(19) United States
(12) Patent Application Publication
(10) Pub. No.: US 2016/0283013 A1
(43) Pub. Date: Sep. 29, 2016

(54) DEVICE DISPLAY CONTROL FOR PROTECTING SENSITIVE DATA

(71) Applicant: Sony Mobile Communications Inc., Tokyo (JP)

(72) Inventors: Richard ENGSTROM, Vintrie (SE); Milan RAKIC, Oxie (SE)

(21) Appl. No.: 14/667,904

(22) Filed: Mar. 25, 2015

(51) Int. Cl. G06F 3/041; G09G 3/34; H04N 9/70; G06F 3/0488; G06F 3/0354; G06T 11/00; G09G 3/36; G06F 3/044

(52) U.S. Cl. CPC G06F 3/0416; G09G 3/3648; G09G 3/3406; G06F 3/0412; G06F 3/044; G06F 3/0488; G06F 3/03545; G06T 11/001; H04N 9/70; G09G 2360/145; G09G 2320/064

(57) ABSTRACT

A device receiving user-customized security parameters related to the display of sensitive data by the device. The device alters the device's display, during display of the sensitive data, based on the user-customized security parameters, wherein altering the device's display includes reducing a backlighting of the display, and modifying an image coloring of the display. The device returns the display to default settings subsequent to the display of the sensitive data.

### BACKGROUND

Many different types of consumer electronics devices typically include a touch screen that may act as an output device that displays image, video and/or graphical information, and which further may act as an input touch interface device for receiving touch control inputs from a user. A touch screen (or touch panel, or touch panel display) may detect the presence and location of a touch within the area of the display, where the touch may include a touching of the display with a body part (e.g., a finger) or with certain objects (e.g., a stylus). Touch screens typically enable the user to interact directly with what is being displayed, rather than indirectly with a cursor controlled by a mouse or touchpad. Touch screens have become widespread in use with various different types of consumer electronic devices, including, for example, cellular radiotelephones, personal digital assistants (PDAs), and hand-held gaming devices.

### SUMMARY

In one exemplary embodiment, a method includes receiving user-customized security parameters related to the display of data by a device having a display, and altering the device's display, during display of the data, based on the user-customized security parameters, wherein altering the device's display comprises: reducing a backlighting of the device's display, and modifying an image coloring of the device's display. The method further includes returning the device's display to default settings subsequent to the display of the data.

In another exemplary embodiment, a device includes a display unit, and a processing unit configured to: receive user-customized security parameters related to the display of data via the display, alter the display unit, during the display of the data, based on the user-customized security parameters, wherein altering the display unit comprises: reducing a backlighting of the device's display unit, and changing coloring of images or data output of the display unit to grayscale; and return the display unit to default settings subsequent to the display of the data.

In yet another exemplary embodiment, a non-transitory computer-readable medium containing instructions executable by at least one processor, the non-transitory computer-readable medium comprising one or more instructions for: receiving user-customized security parameters related to the display of data by a device having a display, wherein the data comprises sensitive data that a user of the device does not want to have others see when displayed on the device's display; altering the device's display, during display of the data, based on the user-customized security parameters, wherein altering the device's display comprises: reducing a backlighting of the device's display, changing a coloring of images or data output of the display to grayscale, and scrambling keys of a displayed input keyboard associated with the display of the data; and returning the device's display to default settings subsequent to the display of the data.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 illustrates an overview of display security measures that may be implemented by a device for protecting the display of sensitive data;

FIGS. 2A and 2B depict an exemplary implementation of the device display of FIG. 1, where the device display includes a self capacitance and/or a mutual capacitance type of touch panel;

FIG. 3 is a block diagram that depicts exemplary components of the device of FIG. 1;

FIGS. 4 and 5 depict an example of the execution of the display security measures described with respect to FIG. 1;

FIG. 6 illustrates an exemplary device user interface that may be displayed via the device display of FIG. 1 to permit user selection and customization of the data display security measures executed by the device;

FIG. 7 is a flow diagram illustrating an exemplary process for executing display security measures for obscuring the viewing of sensitive data on the display of the device of FIG. 1;

FIG. 8 depicts an exemplary implementation in which the backlighting of the device's display is dimmed as a display security measure to obscure the appearance of data on the display to those viewing the display from an angle relative to the device;

FIG. 9 depicts an additional exemplary implementation in which the display image coloring of the device's display is changed to a monochromatic appearing grayscale; and

FIGS. 10A and 10B depict a further exemplary implementation in which a keyboard displayed via the device's display is changed from a default arrangement of keys to a scrambled arrangement of keys.

### DETAILED DESCRIPTION

The following detailed description refers to the accompanying drawings. The same reference numbers in different drawings may identify the same or similar elements. Also, the following detailed description does not limit the invention.

When displaying sensitive data on a display of a device, or when entering sensitive data (e.g., password, pin codes) via a touch screen display of the device, nearby individuals viewing the device at an angle relative to the display of device may be able to discern and, thus, “spy upon” the sensitive data appearing on the display of the device. For example, when a device user is entering a pass code to unlock the device, or is entering a login name and/or password, another individual adjacent to the device may view the device's display from an angle to ascertain the sensitive data being displayed. Embodiments described herein implement display security measures that prevent the disclosure of sensitive data displayed by a device, or sensitive data being entered into the device. The display security measures may include automatically performing reducing backlighting of the display of the device, changing an image coloring of the display of the device to grayscale and/or scrambling a keyboard/keypad of the device. The display security measures performed by the device may be customized by the user of the device. The display security measures described herein may be implemented with respect to devices having touch screen displays, or devices having regular display units (in association with hardware keyboards) that don't have a touch screen capability.

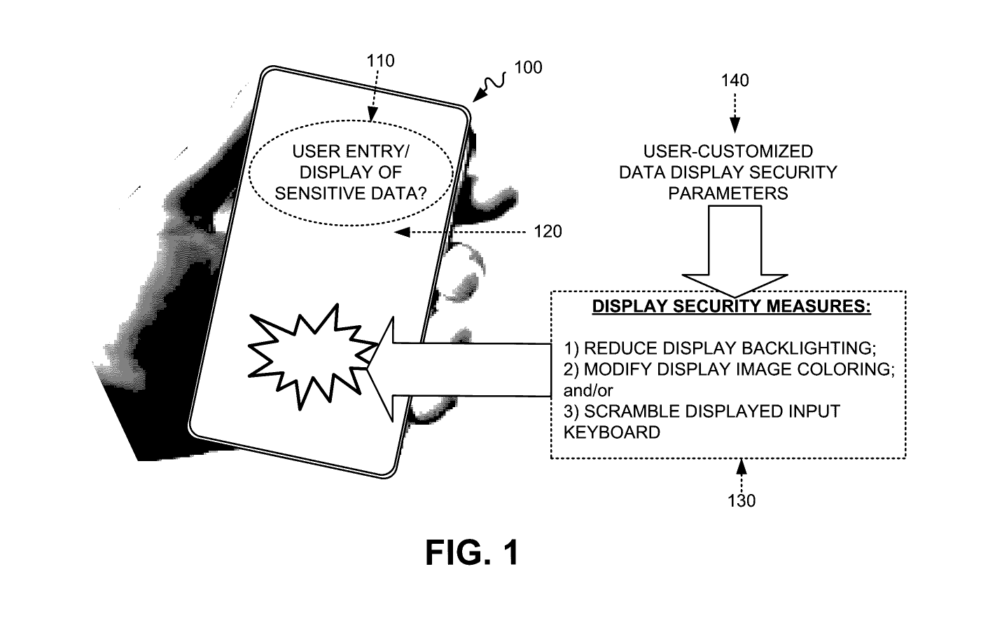

FIG. 1 illustrates an overview of display security measures that may be implemented by a device 100 for protecting the display of sensitive data. As shown, a user (hand shown) of device 100 may want to enter sensitive data into device 100, or may want to display sensitive data at device 100 (identified with reference number “110” in FIG. 1), where entering the sensitive data and displaying the sensitive data at device 100 causes the data to be temporarily displayed on a display 120 of device 110. The temporary display of the sensitive data may enable other individuals, in close proximity to device 100, to see the sensitive data.

To avoid other individuals, in close proximity to device 100, being able to see the sensitive data entered and/or displayed on display 120 of device 100, device 100 may implement display security measures 130 for obscuring the sensitive data entered and/or displayed at device 100. The display security measures 130 may include reducing a backlighting of display 120, modifying a display image coloring of display 120, and/or scrambling an input keyboard or keypad displayed on display 120. Modifying the display image coloring of display 120 may include, for example, changing the image coloring of graphics, images and/or data displayed on display 120 to a grayscale coloring. In one implementation, display security measures 130 may include only reducing the backlighting of display 120. In another implementation, display security measures 130 may include both reducing the backlighting of display 120 and modifying the display image coloring of display 120. In yet another implementation, display security measures 130 may include the combination of reducing the backlighting of display 120, modifying of the display image coloring of display 120, and scrambling an input keyboard or keypad displayed on display 120. Scrambling the input keyboard or keypad displayed on display 120 may include scrambling a numeric keyboard/keypad or scrambling an alpha-numeric keyboard/keypad. In additional implementations, other types of display security measures, not specifically described herein, may be used by themselves, or in conjunction with, one or more of display security measures 130 depicted in FIG. 1.

The user of device 100 may supply user-customized data display security parameters 140 to device 100 for causing the display security measures 130 to be executed at device 100 under certain user-customized conditions/circumstances. The display security parameters 140 may include an indication of which of the display security measures have been selected by the user of device 100 for execution (i.e., the user may customize which display security measures are executed). The display security parameters 140 may additionally specify the conditions upon which selected ones of the display security measures 130 may be executed. For example, the display security parameters 140 may specify that one or more of the display security measures 130 may be executed upon the occurrence of a log-in or password entry by the user of device 100, by a pin code entry by the user of device 100 (e.g., during device “unlock”), during phone number dialing by the user of device 100, during selection of an image(s) to unlock device 100, or during execution of a particular application by the user of device 100. The display security parameters 140 may also specify that one or more display security measures 130 may be executed upon the occurrence of a certain user input, such as, for example, the press of a certain key of a keyboard or keypad of device 100, upon the input of certain biometric data (e.g., fingerprint, voice authentication, etc.), or upon the input of a voice comment or instruction (e.g., “secure display on”). The display security parameters 140 may further include data that specifies the level (e.g., dimmer, brighter, etc.) of the reduced backlighting of display security measures 130. Additional exemplary details of user-customized data display security parameters 140 and display security measures 130 are described further below.

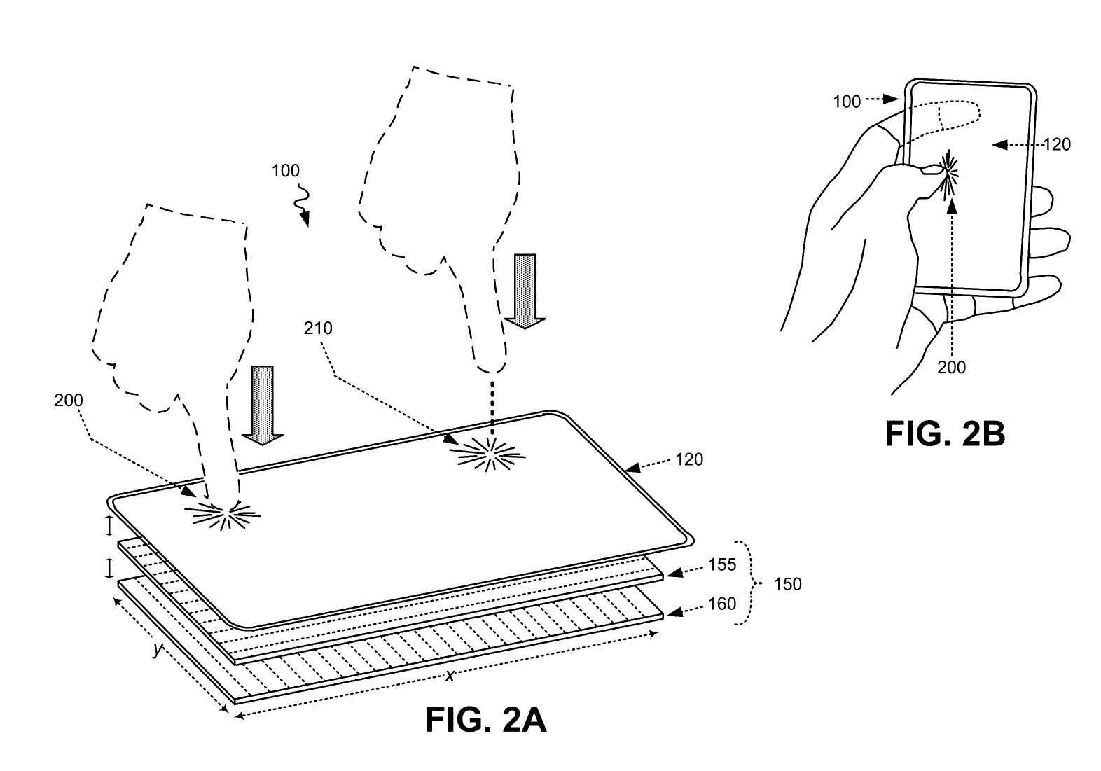

Device 100 may include any type of electronic device that includes a display 120 for displaying graphics, images and/or data. In one implementation, display 120 may include a display for displaying data used in conjunction with a hardware keyboard/keypad. In another implementation, display 120 may include a touch screen display that displays data and may also display a software-generated keyboard/keypad that accepts touch input on the display. Device 100 may include a cellular radiotelephone; a satellite navigation device; a smart phone; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver; a gaming device; a media player device; a tablet computer; a surface table with touch screen display; a wearable computer (e.g., in the form of a watch or glasses); or a digital camera. In some exemplary embodiments, device 100 may include a hand-held electronic device. In one implementation, an example of which is described further with respect to FIGS. 2A and 2B below, display 120 of device 100 may include a touch screen display that further includes a touch panel that operates as a user input device.

When device 100 includes a touch screen display for display 120, the touch panel of display 120 may be integrated with, and/or overlaid on, display 120 to form a touch screen or a panel-enabled display that may function as a user input interface. For example, in one implementation, the touch panel may include a capacitive type of touch panel that allows a touch screen display to be used as an input device. The capacitive type of touch panel may include both a self capacitance and a mutual capacitance type of touch panel (e.g., a Floating Touch™ display using self capacitance and mutual capacitance scanning) In other implementations, other types of near field-sensitive, acoustically-sensitive (e.g., surface acoustic wave), photo-sensitive (e.g., infrared), and/or any other type of touch panel may be used that allows a display to be used as an input device. In some implementations, the touch panel may include multiple touch-sensitive technologies. Generally, the touch panel may include any type of technology that provides the ability to identify the occurrence of a touch upon the touch panel.

The display 120 of device 100 may include a device that can display signals generated by the electronic device 100 as text or images on a screen (e.g., a liquid crystal display (LCD), a cathode ray tube (CRT) display, a light emitting diode (LED) display such as an organic light-emitting diode (OLED) display, a surface-conduction electro-emitter display (SED), a plasma display, a field emission display (FED), a bistable display, etc.). In certain implementations, the display may provide a high-resolution, active-matrix presentation suitable for the wide variety of applications and features associated with typical devices. Display 120 may provide visual information to the user and serve—in conjunction with the touch panel—as a user interface to detect user input. The terms “touch” or “touch input,” as used herein, may refer to a touch of an object upon the touch panel of display 120, such as a body part (e.g., a finger) or a pointing device, or movement of an object (e.g., body part or pointing device) to within a certain proximity of the touch panel that can be sensed as a “touch” by the touch panel.

FIGS. 2A and 2B depict an exemplary implementation of display 120 of device 100, where display 120 is a touch screen display that is also associated with a touch panel 150 In the exemplary implementation depicted in FIGS. 2A and 2B, touch panel 150 is a self capacitance and/or a mutual capacitance type of touch panel (e.g., a Floating Touch™ display using self capacitance and mutual capacitance scanning) However, other types of displays, including different types of touch screen displays, may be used in conjunction with the display security measures described herein.

As shown in the exploded view of FIG. 2A, touch panel 150 further includes a touch input sensor array having arrays of sensors for detecting a touch input upon touch panel 150. The touch input sensor array of touch panel 150 may further include a first layer 155 having multiple parallel rows of capacitive electrodes extending in a y direction (as shown in FIG. 2A), and a second layer 160 having multiple parallel columns of capacitive electrodes extending in an x direction that is perpendicular to they direction (as shown in FIG. 2A). Layers 155 and 160 may be separated by a layer of material, such as, for example, a dielectric layer. The parallel rows of the capacitive sensors of layer 155 may be perpendicular to the parallel columns of the capacitive sensors of layer 160. Device 100 may perform “mutual capacitance” scanning and/or “self capacitance” scanning of the touch input sensor array of touch panel 150. During self capacitance scanning of layers 155 and 160 of the touch sensor array, a voltage is applied to each row of layer 155 and to each column of layer 160. When a finger, or other object, is near, or touching, display 120, a capacitance C_{row} associated with an underlying row electrode of layer 155 increases, and a capacitance C_{column} associated with an underlying column electrode of layer 160 increases. By detecting the increases in capacitance, the location of the finger, or other object, near or touching touch panel 150 of display 120 can be determined by the intersection of the row electrode of layer 155 having an increased capacitance with the column electrode of layer 160 having an increased capacitance. During this “self capacitance” scanning of the touch input sensor array, the current on each row and column electrode may be measured to ground to determine the change in capacitance.

During a “mutual capacitance” scanning of layers 155 and 160, a voltage is applied to a parallel plate capacitor effectively formed at an intersection of each row of layer 155 and column of layer 160. Each intersection of a row of layer 155 and a column of layer 160 represents a single mutual capacitance sensor of the touch sensor array. When a finger(s), or other object(s), touches display 120 and touch panel 150, a capacitance C_{row-column} associated with an intersection, at a location of the touch, of a row electrode of layer 155 and a column electrode of layer 160 decreases. By detecting the decreases in capacitance at one or more row/column intersections, the location of the finger(s), or other object(s), touching display 120 and touch panel 150 can be determined. During this “mutual capacitance” scanning of the touch input sensor array, the capacitance C_{row-column} at each intersection of a row of layer 155 and a column of layer 160 may be measured to determine the change in capacitance.

In the exploded view depicted in FIG. 2A, different touch inputs 200 and 210 are occurring upon display 120. The object (on the left) touching display 120, or the object moving within a certain proximity of a surface of display 120 (on the right), is depicted as a finger. As shown on the left in FIG. 2A, or in FIG. 2B, the touch input sensor array of touch panel 150 may enable touch input 200 to be detected when the object (e.g., finger) touches display 120 and touch panel 150. As further shown on the right in FIG. 2A, the touch input sensor array of touch panel 150 may enable a touch input 210 to be detected when the object (e.g., finger) moves within a certain proximity of touch panel 150 even when the object has not physically touched touch panel 150.

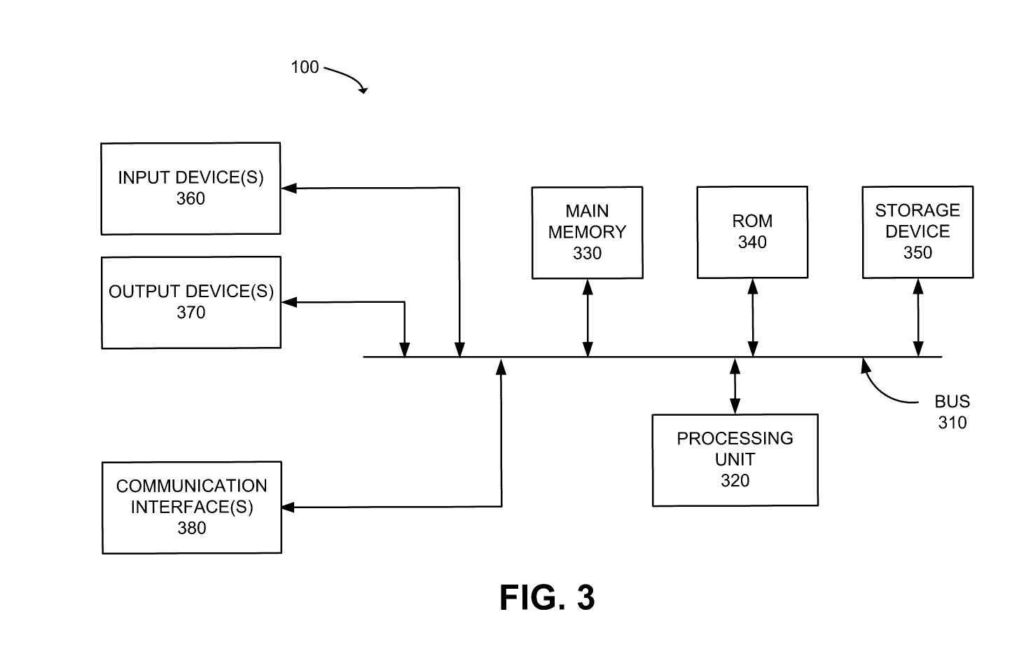

FIG. 3 is a block diagram that depicts exemplary components of device 100. As illustrated, device 100 may include a bus 310, a processing unit 320, a main memory 330, a read only memory (ROM) 340, a storage device 350, an input device(s) 360, an output device(s) 370, and a communication interface(s) 380. Bus 310 may include a path that permits communication among the elements of device 100.

Processing unit 320 may include a processor, microprocessor, or processing logic that may interpret and execute instructions. Main memory 330 may include a random access memory (RAM) or another type of dynamic storage device that may store information and instructions for execution by processing unit 320. ROM 340 may include a ROM device or another type of static storage device that may store static information and instructions for use by processing unit 320. Storage device 350 may include a magnetic and/or optical recording medium and its corresponding drive. Main memory 330, ROM 340 and storage device 350 may each be referred to herein as a “tangible non-transitory computer-readable medium.”

Input device 360 may include a mechanism that permits a user to input information to device 100, such as a mouse, a pen, voice recognition and/or biometric mechanisms, etc. Input device 360 may further include display 120, which includes a touch screen display having touch panel 150. Output device 370 may include a mechanism that outputs information to the operator, including a display, a printer, a speaker, etc. Output device 370 may additionally include display 120 that includes the touch screen display (and touch panel 150) that also acts as an input device 360. Communication interface 380 may include a transceiver that enables device 100 to communicate with other devices and/or systems.

Device 100 may perform certain operations or processes described herein. Device 100 may perform these operations in response to processing unit 320 executing software instructions contained in a computer-readable medium, such as memory 330. A computer-readable medium may be defined as a physical or logical memory device. The software instructions may be read into memory 330 from another computer-readable medium, such as data storage device 350, or from another device via communication interface 380. The software instructions contained in memory 330 may cause processing unit 320 to perform operations or processes described herein. Alternatively, hardwired circuitry may be used in place of or in combination with software instructions to implement processes described herein. Thus, implementations described herein are not limited to any specific combination of hardware circuitry and software.

The configuration of components of device 100 illustrated in FIG. 3 is for illustrative purposes only. Other configurations may be implemented. Therefore, device 100 may include additional, fewer and/or different components, or differently arranged components, from those depicted in FIG. 3.

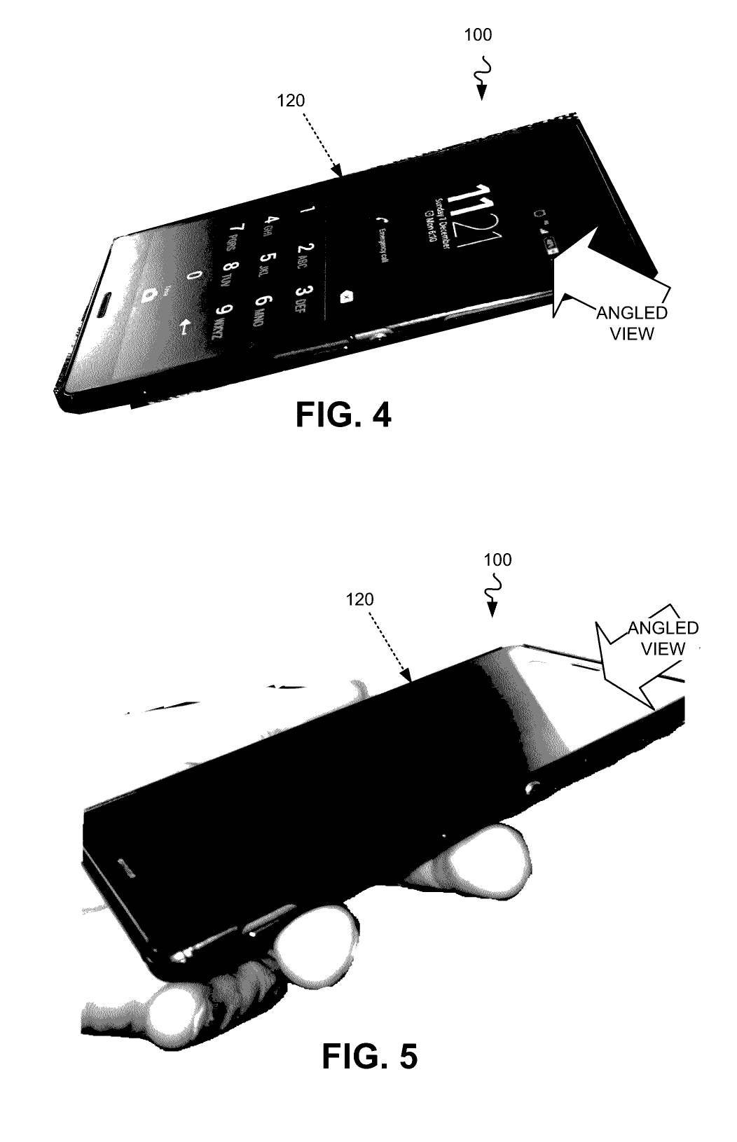

FIGS. 4 and 5 depict an example of the execution of the display security measures described above with respect to FIG. 1, including reduction of backlighting of display 120 of device 100, and changing the display image coloring of display 120 of device 100, for obscuring sensitive data displayed on display 120. FIG. 4 shows an initial angled side view of display 120 of device 100, with no display security measures being executed. The angled side view of display 120 shown in FIG. 4 includes the view that someone located in the vicinity of device 100 would see. As seen in FIG. 4, data displayed via display 120 can clearly be seen by nearby individuals in close proximity to device 100. FIG. 5 depicts another angled side view of display 120 of device 100 with the display security measures, including the reduction of the backlighting of the display and the changing of the display image coloring of display 120 of device 100, being executed. As seen in FIG. 5, no sensitive data displayed via display 120 can be seen by nearby individuals in close proximity to device 100 to the reduced backlighting of display 120.

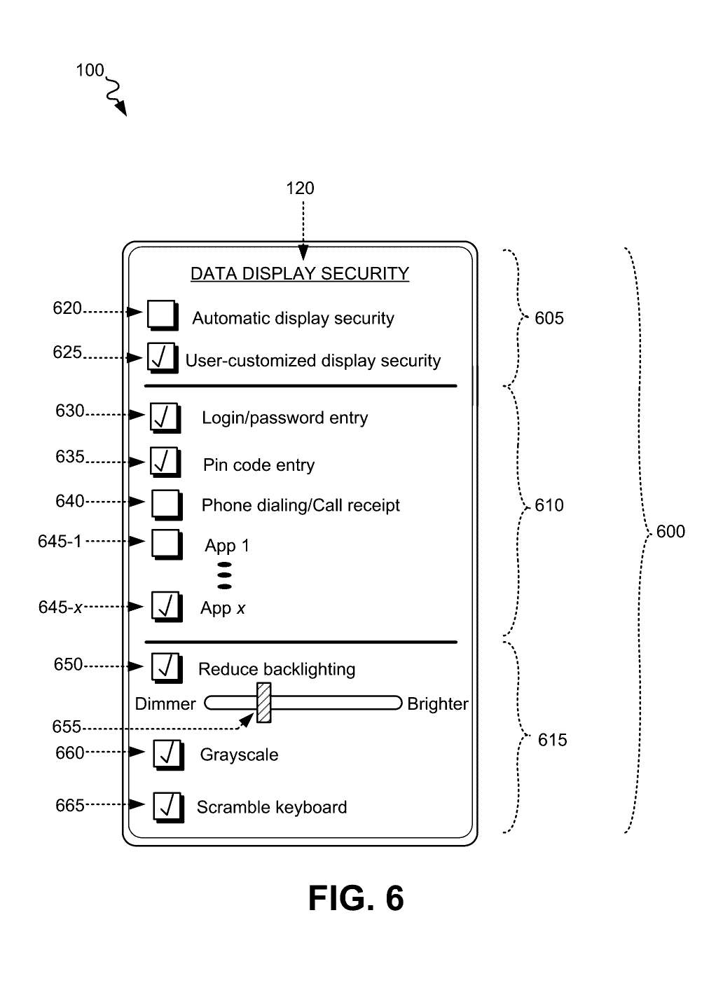

FIG. 6 illustrates an exemplary user-customized data display security parameter user interface 600 that may be displayed via display 120 to permit user selection and customization of the data display security measures executed by device 100. In the exemplary implementation depicted in FIG. 6, display 120 of device 100 may include a touch screen display where display 120 serves as both input device 360 and output device 370 of device 100.

User interface 600 may include a user interface section (and/or window or screen) 605 that permits the user of device 100 to select a first option 620 that causes display security measures to be automatically executed, or a second option 625 that causes display security measures to be executed based on user-customized data display security parameters input into device 100 via, for example, user interface 600. In the example shown in FIG. 6, the user of device 100 may “touch” a box associated with option 620 or option 625 to cause the box to be “checked,” indicating that the option has been selected. In this example, if option 620 is selected, then option 625 cannot be selected, and if option 625 is selected then option 620 cannot be selected. The automatic execution of display security measures selected by user selection of option 620 may be executed based on the occurrence of default conditions (e.g., whenever a password or pin code is entered by the user of device 100).

User interface 600 may include another user interface section (and/or window or screen) 610 that permits the user of device 100 to select the conditions or events under which the data display security measures are executed. As shown in FIG. 6, the conditions or events may include login/password entry 630, pin code entry 635, phone dialing/call receipt 640, and the execution of specific applications (apps) 1 through x 645-1 through 645-x. Selection of login/password entry 630 in user interface section 610 causes device 100 to execute data display security measures whenever device 100 requests the user to enter a login name and/or password via input device 360. Selection of pin code entry 635 causes device 100 to execute data display security measures whenever device 100 requests the user to enter a pin code via input device 360. Selection of phone dialing/call receipt 640 causes device 100 to execute data display security measures whenever the user of device 100 is selecting a telephone number (e.g., entering key selections associated with a telephone number) to call from device 100, or when a call is received at device 100, and the corresponding telephone number of the calling party is displayed via display 120. In other implementations, “phone dialing” and “call receipt” shown with respect to phone dialing/call receipt 640 of FIG. 6 may be two separate optional conditions selectable via user interface 600 (i.e., two independent check boxes), as opposed to a single selectable option as depicted in FIG. 6. Selection of any of apps 645-1 through 645-x causes device 100 to execute data display security measures when the particular selected apps are executed at device 100 (e.g., during the execution of the particular selected app(s)). In the example shown in FIG. 6, the user of device 100 may “touch” any of the boxes associated with login/password entry 630, pin code entry 635, phone dialing/call receipt 640, and the execution of specific applications (apps) 1 through x 645-1 through 645-x and any or all of those selections may serve as a condition or event that causes data display security measures to be executed.

User interface section 610 may also (not shown in FIG. 6) enable the user to specify “action” hardware keys on device 100 that, when activated (i.e., pressed) by the user, cause one or more of the display security measures to be executed. In this case, display security measures may not be executed automatically, but only upon activation of one of the “action” hardware keys. Alternatively, the display security measures may be executed automatically, but may also be executed upon activation of one of the “action” hardware keys. Each one of the “action” hardware keys may select a different one of, or combination of, the display security measures to be executed. For example, <key 1> may select backlighting reduction, <key 2> may select grayscale display image coloring, <key 3> may select keyboard scrambling, <key 4> may select backlighting reduction and grayscale display image coloring, and <key 5> may select backlighting reduction, grayscale display image coloring, and keyboard/keypad scrambling. Activating (i.e., pressing) each of the “action” hardware keys may discontinue a respective display security measure previously selected by the user of device 100.

User interface 600 may include an additional user interface section (and/or window or screen) 615 that permits the user of device 100 to select which particular display security measures may be executed upon the occurrence of events or conditions selected via user interface section 610. As shown in FIG. 6, the user may select a “reduce backlighting” display security measure 650, a “grayscale” display security measure 660 and a “scramble keyboard” 665 display security measure. Selection of “reduce backlighting” display security measure 650 causes device 100 to reduce the backlighting of display 120 upon the occurrence of conditions or events selected by the user of device 100 via user interface section 610. As further shown in FIG. 6, the user of device 100 may additionally select a backlighting level via a “slider” control 655 that permits the user to select the dimness or brightness of the backlighting. The user may “touch” slider control 655, and then “drag” the slider control 655 in the particular direction of “dimmer” or “brighter” backlighting that the user desires when the backlighting display security measure is executed. Selection of “grayscale” display security measure 660 causes device 100 to change the display image coloring of display 120 upon the occurrence of conditions or events selected by the user of device 100 via user interface section 610. A grayscale display image coloring includes a range of gray shades from white to black. In grayscale images, each pixel is only associated with intensity information such that the images are composed exclusively of shades of gray. Selection of “scramble keyboard” display security measure 665 causes device 100 to scramble a keyboard or keypad associated with the entry of sensitive data by the user of device 100. For example, if the user is entering a pin code, scrambling the key pad provides a further measure of display security that obscures the pin code being entered by the user. Scrambling the keyboard or keypad involves changing the order and/or arrangement of “soft” keys of the keyboard/keypad as displayed via display 120.

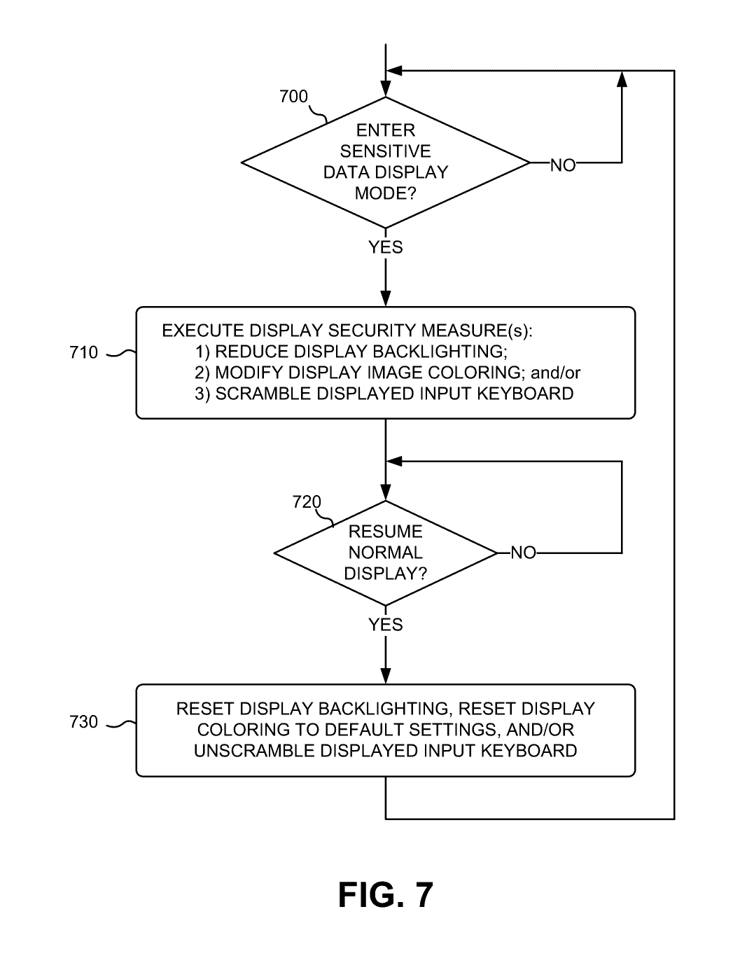

FIG. 7 is a flow diagram illustrating an exemplary process for executing display security measures for obscuring the viewing of sensitive data on display 120 of device 100. The exemplary process of FIG. 7 may be performed by processing unit 320 of device 100 in conjunction with display 120. The exemplary process of FIG. 7 may be executed continuously during operation of device 100 when display 120 is active (e.g., powered on).

The exemplary process may include device 100 determining whether to enter a sensitive data display mode (block 700). Device 100 may enter a sensitive data display mode automatically based on the occurrence of specific condition or event, where the specific condition or event may be a default condition or event, the occurrence of which always causes device 100 to enter the sensitive data display mode, or the specific condition or event may be one of a set of conditions or events specified by the user of device 100 via user-customized data display security parameters 140. For example, referring again to FIG. 6, the user of device 100 may select the user-customized option 625 from section 605 of user interface 600, and may then select one or more conditions or events 630, 635, 640 and/or 645-1 through 645-x that specify when device 100 enters a sensitive data display mode. For example, if login/password entry 630 is selected from user interface 600, then device 100 may enter the sensitive data display mode when a login name and/or password is entered into device 100. As another example, if app 1 645-1 (e.g., a text-messaging app, an email app, or some other app) is selected from user interface 600, then device 100 may enter the sensitive data display mode when app 1 is executed by device 100.

Device 100 may execute one or more display security measures to: 1) reduce backlighting of display 120, 2) modify display image coloring of display 120, and/or 3) scramble an input keyboard/keypad displayed on display 120 (block 710). Device 100 may execute 1) by itself; 2) by itself; 3) by itself; 1) and 2) in combination; 2) and 3) in combination; 1) and 3) in combination; or 1), 2) and 3) in combination. Additional display security measures, not specifically described herein, may be used alone or in conjunction with one or more of display security measures 1), 2), and/or 3) above. Device 100 may execute the one or more display security measures automatically based on default settings, or based on user-customized settings. The user-customized settings may, for example, be set by the user of device 100 via user interface 600 of FIG. 6, including selecting “reduce backlighting” 650, “grayscale” 660 and/or “scramble keyboard” 665. The user-customized settings may further include a user-customized backlighting level set “slider” control 655 of user interface 600 that permits the user to select the dimness or brightness of the backlighting.

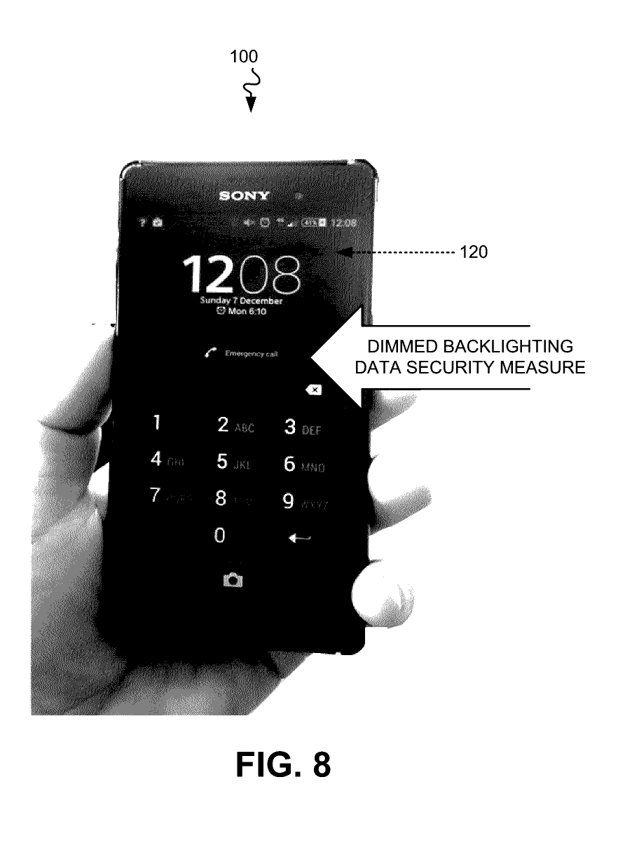

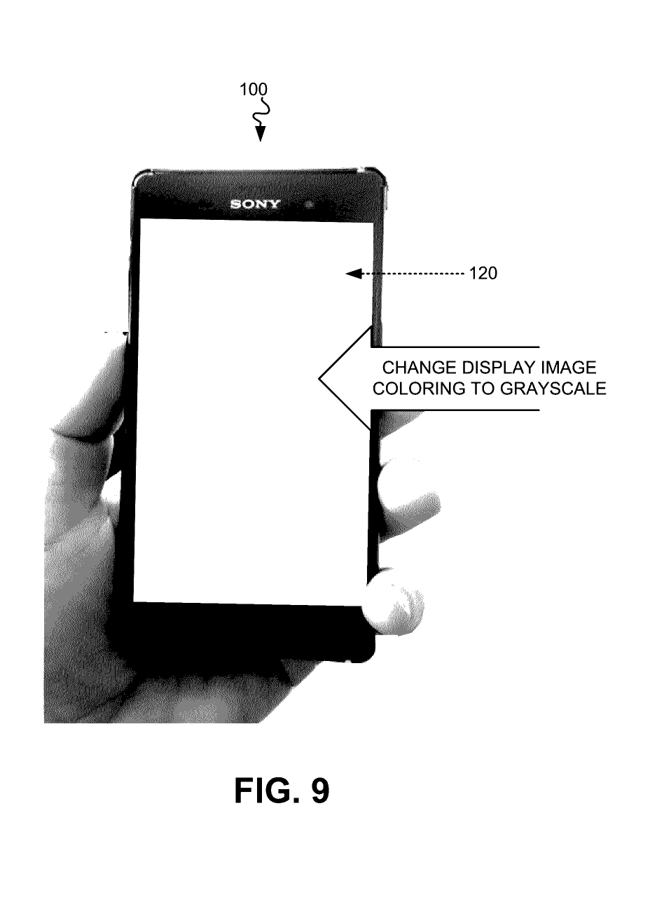

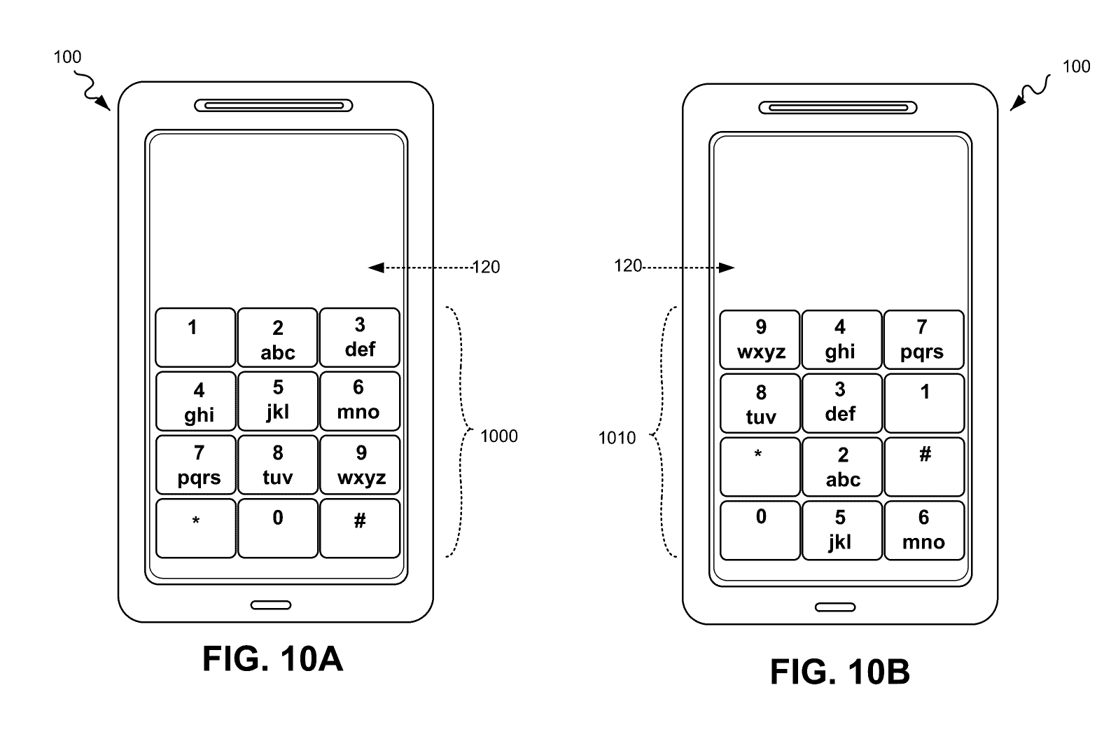

FIG. 8 depicts an exemplary implementation in which the backlighting of display 120 of device 100 is dimmed as a display security measure to obscure the appearance of data on display 120 to those, other than the user holding device 100 and viewing display 120 straight on, possibly viewing display 120 from an angle within close proximity to device 100. FIG. 9 additionally depicts an exemplary implementation in which the display image coloring of display 120 of device 100 is changed to a monochromatic appearing grayscale. FIGS. 10A and 10B depict a further exemplary implementation in which a keyboard displayed via display 120 of device 100 is changed from a default arrangement 1000 and order of keys to a scrambled arrangement 1010 and order of keys. Scrambling the arrangement of the keys when, for example, the user of device 100 is entering input data (e.g., a pin code, a password), assists in obscuring the input from other individuals that may be viewing display 120 of device from a location adjacent to the user of device 100. Execution of the backlighting reduction of FIG. 8 and the grayscale image coloring of FIG. 9 results in the obscured view of displayed data as shown, for example, in FIG. 5, where another individual attempts to view (or “spy upon”) display 120 from an angle at a location adjacent to the user of device 100.

Device 100 may determine whether to resume a normal display and discontinue the display security measures executed in block 710 (block 720). Device 100 may resume the default display when, for example, login, password or pin code entry completes, when a phone number is finished being dialed, and/or when a particular app is no longer executing. If the normal default display is to be resumed (YES-block 720), then device 100 may discontinue execution of the display security measures, including resetting the backlighting of display 120 to a default setting, resetting the display image coloring to a default setting, and/or unscrambling the displayed input keyboard/keypad (block 730). Images, graphics and/or data displayed at display 120 of device 100 may be returned to a normal default mode, with the default backlighting level, default display image coloring, and a keyboard/keypad that is unscrambled and displayed in its default state.

The foregoing description of the embodiments described herein provides illustration and description, but is not intended to be exhaustive or to limit the invention to the precise form disclosed. Modifications and variations are possible in light of the above teachings or may be acquired from practice of the invention. For example, while a series of blocks has been described with respect to FIG. 7, the order of the blocks may be varied in other implementations. Moreover, non-dependent blocks may be performed in parallel. In additional embodiments, device 100 may have a sensor to sense that someone (other than the user of device 100) is in close proximity to device 100 and, if someone is sensed in close proximity, device 100 enters the sensitive display mode (e.g., block 700) and executes the display security measure(s) of block 710. In further embodiments, different levels of data security measures may be used for different types of data and/or different apps. For example, one type of data or app causes grayscale image coloring to be executed, whereas higher security data or apps causes grayscale image coloring and backlighting reduction to be executed. In such an implementation, a type of data or app having a highest level of security may cause the most image color changing, a highest amount of backlighting reduction, and keyboard scrambling to be executed. In yet another implementation, pressing a hardware key on device 100 multiple times may increase the display security measures that are executed for each press of the hardware key.

Certain features described herein may be implemented as “logic” or as a “unit” that performs one or more functions. This logic or unit may include hardware, such as one or more processors, microprocessors, application specific integrated circuits, or field programmable gate arrays, software, or a combination of hardware and software.

The term “comprises” or “comprising” as used herein, including the claims, specifies the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Further, the phrase “based on,” as used herein is intended to mean “based, at least in part, on” unless explicitly stated otherwise.

What is claimed is:

1. A method, comprising:
receiving user-customized security parameters related to the display of data by a device having a display;
altering the device's display, during display of the data, based on the user-customized security parameters, wherein altering the device's display comprises:
reducing a backlighting of the device's display, and
modifying an image coloring of the device's display; and
returning the device's display to default settings subsequent to the display of the data.

2. The method of claim 1, wherein the data comprises sensitive data that a user of the device does not want to have others see when displayed on the device's display.

3. The method of claim 1, further comprising:
receiving the user-customized security parameters via a user interface of the device.

4. The method of claim 3, wherein the user-customized security parameters comprise an indication of whether altering the device's display during display of the data should be automatically performed or should be performed under user-specified conditions.

5. The method of claim 3, wherein the user-customized security parameters comprise a user-specified brightness setting of the backlighting of the device's display.

6. The method of claim 3, wherein the user-customized security parameters comprise an indication whether keys of an input keyboard displayed via the device's display are to be scrambled during the display of the data.

7. The method of claim 1, wherein returning the device's display to default settings comprises:
returning the backlighting of the device's display to one of the default settings; and
returning the image coloring of the device's display to one of the default settings.

8. The method of claim 1, wherein modifying the image coloring comprises:
changing the image coloring to grayscale.

9. The method of claim 1, wherein altering the device's display further comprises:
scrambling keys of a displayed input keyboard associated with the display of the data.

10. The method of claim 1, further comprising:
automatically identifying whether the data to be displayed on the device's display comprises sensitive data,
wherein altering the device's display is further based on the identification whether the data comprises sensitive data.

11. A device, comprising:
a display unit; and
a processing unit configured to:
receive user-customized security parameters related to the display of data via the display,
alter the display unit, during the display of the data, based on the user-customized security parameters, wherein altering the display unit comprises:
reducing a backlighting of the device's display unit, and
changing coloring of images or data output of the display unit to grayscale; and
return the display unit to default settings subsequent to the display of the data.

12. The device of claim 11, wherein the display unit comprises a touch screen display.

13. The device of claim 11, wherein the data comprises sensitive data that a user of the device does not want to prevent others from ascertaining when displayed via the display unit.

14. The device of claim 11, wherein the processing unit is further configured to receive the user-customized security parameters via a user interface of the device, and
wherein the user-customized security parameters comprise:
an indication of whether altering the display unit during display of the data should be automatically performed or should be performed under user-specified conditions,
a user-specified brightness setting of the backlighting of the display unit, or
an indication whether keys of an input keyboard displayed via the display unit should be scrambled during the display of the data.

15. The device of claim 14, wherein, when altering the display unit, the processing unit is further configured to:
scramble keys of a displayed input keyboard associated with the display of the data based on the indication that the keys of the input keyboard displayed via the display unit should be scrambled.

16. The device of claim 11, wherein the processing unit is further configured to:
identify whether the data to be displayed on the device's display unit comprises sensitive data,
wherein altering the device's display unit is further based on the identification whether the data comprises sensitive data.

17. The device of claim 11, wherein the device comprises one of a cellular radiotelephone, a satellite navigation device, a smart phone, a Personal Communications System (PCS) terminal, a personal digital assistant (PDA), a gaming device, a media player device, a tablet computer, a surface table, a wearable computer, or a digital camera.

18. A non-transitory computer-readable medium containing instructions executable by at least one processor, the non-transitory computer-readable medium comprising one or more instructions for:
receiving user-customized security parameters related to the display of data by a device having a display, wherein the data comprises sensitive data that a user of the device does not want to have others see when displayed on the device's display;
altering the device's display, during display of the data, based on the user-customized security parameters, wherein altering the device's display comprises:
reducing a backlighting of the device's display,
changing a coloring of images or data output of the display to grayscale, and
scrambling keys of a displayed input keyboard associated with the display of the data; and
returning the device's display to default settings subsequent to the display of the data.

19. The non-transitory computer-readable medium of claim 18, wherein the user-customized security parameters comprise at least one of:
an indication of whether altering the device's display during display of the data should be automatically performed or should be performed under user-specified conditions,
a user-specified brightness setting of the backlighting of the device's display, or
an indication whether keys of the input keyboard displayed via the device's display should be scrambled during the display of the data.

20. The non-transitory computer-readable medium of claim 18, wherein returning the device's display to default settings comprises:
returning the backlighting of the device's display to one of the default settings;
returning the image coloring of the device's display to one of the default settings; and
returning the scrambled keys of the displayed input keyboard to a default unscrambled state.
